(19) United States
(12) Patent Application Publication
(10) Pub. No.: US 2010/0136393 A1
(43) Pub. Date: Jun. 3, 2010

(54) LITHIUM ION SECONDARY BATTERY

(76) Inventors: Hideharu Takezawa, Nara (JP); Masato Fujikawa, Osaka (JP); Miyiki Nakai, Osaka (JP); Shinji Kasamatsu, Osaka (JP); Tomohiko Yokoyama, Osaka (JP)

Correspondence Address: MCDERMOTT WILL & EMERY LLP, 600 13TH STREET, NW, WASHINGTON, DC, 20005-3096, US

(21) Appl. No.: 12/595,001

(22) PCT Filed: Jul. 17, 2008
(86) PCT No.: PCT/JP2008/001918

§ 371 Date: Oct. 7, 2009

(30) Foreign Application Priority Data
Jul. 27, 2007 (JP) 2007-196035
Jul. 16, 2008 (JP) 2008-184420

(51) Int. Cl. H01M 6/10; H01M 4/58; H01M 4/00

(52) U.S. Cl. 429/94; 429/231.95; 429/223

(57) ABSTRACT

In a lithium ion secondary battery, a lithium-nickel-containing composite oxide that contains lithium and nickel is used as a positive electrode active material, and a negative electrode active material having a melting temperature of 1200° C. or less in a lithium-absorbed state is included in a negative electrode active material layer. By configuring as above, in the lithium ion secondary battery, it is possible to achieve higher capacity, higher output, and longer life, as well as further improved safety, and particularly in a nail penetration test, to suppress the heat generation due to internal short circuit and to reliably prevent the occurrence of thermal runaway.

### TECHNICAL FIELD

The present invention relates to lithium ion secondary batteries. More particularly, the present invention mainly relates to an improvement of a negative electrode.

### BACKGROUND OF THE INVENTION

Lithium ion secondary batteries have high capacity and high energy density, and thus can be easily made small-sized and lightweight, so that they are widely used for a power source of portable small electronic devices, such as for example mobile phones, personal digital assistants (PDA), notebook personal computers, camcorders, and portable game devices. Lithium ion secondary batteries typically include an electrode assembly including a positive electrode, a separator, and a negative electrode. The positive electrode includes a positive electrode active material layer containing a lithium cobalt compound and being formed on an aluminum foil (positive electrode current collector) surface. The separator is a polyolefin-made porous film. The negative electrode includes a negative electrode active material layer containing a carbon material and being formed on an aluminum foil (negative electrode current collector) surface. The electrode assembly is placed in a battery can.

Such batteries have high capacity, output, and long life. Also, such batteries do not have a significant problem in practical use in terms of safety. However, there is still room for further improvement in securing safety for users more reliably.

As a test for evaluating battery's safety, nail penetration tests are known. The nail penetration test is a testing method for evaluating battery safety by for example allowing a nail to penetrate in the layering direction of the electrode assembly to forcibly generate an internal short circuit, and examining the degree of heat generation. When the nail penetration test is carried out for the above-described lithium ion secondary batteries, first, an internal short circuit occurs between the positive electrode current collector and the negative electrode current collector via the nail. This causes local heat generation in the battery, and the temperature becomes high, i.e., about 600 to 800° C., at the portion where the positive electrode current collector and the negative electrode current collector are in contact with the nail and its surrounding. Since the melting point of aluminum is about 600° C., a portion of the positive electrode current collector that is in contact with the nail melts at an area, and the short circuit between the current collectors ends.

However, because the internal short circuit between the active material layers further advances, the battery temperature increases even further. This causes the separator to melt and a surface-to-surface short circuit between the active material layers occurs without the intervention of the nail, causing heat generation to be more notable and a possibility of thermal runaway. Note that this is clearly a result of a nail penetration test, and even if an internal short circuit actually occurred in a battery product, the above-described heat generation hardly occurs. However, even if it is a result of a nail penetration test, less heat generation clearly achieves higher safety. Further improving the results of the nail penetration test would probably be effective in securing safety for users even if for example the battery product is used under circumstances unexpected by manufacturers.

Meanwhile, with lithium ion secondary batteries being remarkably widespread, there is a demand for lithium ion secondary batteries having even higher capacity. For high capacity lithium ion secondary batteries, various proposals have been made, including for example, selecting high capacity positive electrode active material and negative electrode active material, optimizing the positive electrode active material and the negative electrode active material themselves, and optimizing their combination.

As a high capacity negative electrode active material, alloy-based negative electrode active materials such as silicon, tin, oxides thereof, compounds containing these, alloys containing these and the like are gaining attention. The alloy-based negative electrode active materials absorb lithium by forming an alloy with lithium, and reversibly absorb and desorb lithium. The alloy-based negative electrode active material has high discharge capacity, and therefore is effective for achieving high capacity lithium ion secondary batteries. For example, the theoretical discharge capacity of silicon is about 4199 mAh/g, and this is about eleven times the theoretical discharge capacity of graphite, which has been conventionally used as the negative electrode active material.

A high capacity positive electrode active material also includes a lithium-nickel-containing composite oxide that contains lithium and nickel. For example, although LiNiO₂ has been increasingly used for commercially available lithium ion secondary batteries, there are problems in terms of cycle performance and safety. Therefore, in recent days, for achieving ever higher capacity, higher safety, and longer life, improvements in lithium-nickel-containing composite oxides are underway.

There has been proposed, for example, a lithium-nickel-containing composite oxide represented by LiₘM5ₙNiₒCoₚO_{q}, where M5 is at least one element selected from the group consisting of Al, Mn, Sn, In, Fe, V, Cu, Mg, Ti, Zn, and Mo; and 0<m<1.3, 0.02≦n≦0.5, 0.02≦o/(o+p)≦0.9, 1.8<q<2.2, and n+o+p=1 (for example, see Patent Document 1). This compound is capable of achieving high capacity due to its stable crystal structure, and in terms of safety (thermal stability) as well, it is improved more than the conventional ones.

In addition, there has been suggested, for example, using in a lithium ion secondary battery a combination of an alloy-based negative electrode active material and a positive electrode active material being a lithium-nickel-containing composite oxide (for example, see Patent Document 2). However, specifically disclosed in the Patent Document 2 as the negative electrode active material is a material that is mainly composed of a tin oxide, and contains at least one element selected from the group consisting of a Group 1 element, a Group 2 element, a Group 13 element, a Group 14 element, and a Group 15 element of the periodic table, a transition element, and a halogen element; therefore, strictly, it is different from the alloy-based negative electrode active material. In the Patent Document 2, a particulate negative electrode active material is made, and this is mixed with a binder resin to form a negative electrode active material layer. That is, a thin film negative electrode active material layer that does not include a binder resin and is mainly composed of an alloy-based negative electrode active material is not formed.

Further, a combination of tin and a lithium-nickel-containing composite oxide (LiᵣNi₍₁₋ₛ₋ₜ₎CoₛM6ₜO₂, M5=Al or Mn, 0.3≦r≦1, 0.1≦s≦0.4, 0.01≦t≦0.2) has been disclosed (for example, see Patent Document 3). The Patent Document 3 as well only describes forming tin into a sheet and using the sheet as the negative electrode as it is, or mixing tin particles with a binder resin to form a negative electrode active material layer.

Furthermore, a combination of an alloy-based negative electrode active material being a simple substance of silicon, tin and the like, or an alloy or a compound thereof, and a lithium-nickel-containing composite oxide has been disclosed (for example, see Patent Document 4). However, the Patent Document 4 also merely describes mixing particles of the alloy-based negative electrode active material with a binder resin to form a negative electrode active material layer.

The level of heat generation cannot be sufficiently decreased to reliably prevent the thermal runaway at the time of a safety test such as the nail penetration test by merely combining the alloy-based negative electrode active material and the lithium-nickel-containing composite oxide, as in the above Patent Documents 2 to 4.

On the other hand, it has been known that a thin film negative electrode active material layer mainly composed of an alloy-based negative electrode active material is formed on the surface of a current collector by means of a sputtering method, a deposition method, and the like (for example, see Patent Document 5). However, in the Patent Document 5, the only positive electrode active material that can be used in combination with the thin film negative electrode active material layer is lithium cobalt oxide, which is a lithium-cobalt-containing composite oxide, and there is no description at all regarding the lithium-nickel-containing composite oxide. Further, there is no description at all about use of the thin film negative electrode active material layer mainly composed of the alloy-based negative electrode active material along with a lithium-nickel-containing composite oxide to achieve a lithium ion secondary battery with further improved safety, on top of high capacity, high output, and long life.

Patent Document 1: Japanese Laid-Open Patent Publication No. Hei 5-242891
Patent Document 2: Japanese Laid-Open Patent Publication No. Hei 10-294100

### Patent Document 3: Japanese Laid-Open Patent Publication No. 2003-331918

Patent Document 4: International Publication No. WO 2003/019713

### Patent Document 5: Japanese Laid-Open Patent Publication No. 2006-196447

### DISCLOSURE OF THE INVENTION

### Problem to be Solved by the Invention

An object of the present invention is to provide a lithium ion secondary battery having high capacity, high output, and long life, with further improved safety.

### Means for Solving the Problem

The inventors of the present invention focused on a combination of an alloy-based negative electrode active material and a lithium-nickel-containing composite oxide in the course of their examination for solving the above problems, especially for achieving high capacity and high output. Then, it was revealed that when the alloy-based negative electrode active material particles are mixed with a binder resin to form the negative electrode active material layer, further improvement in safety could not be achieved.

Thus, as a result of further examination by the inventors of the present invention, it was found that heat generation at the time of nail penetration tests can be curbed and occurrence of thermal runaway can be prevented when the thin film negative electrode active material layer mainly composed of an alloy-based negative electrode active material is formed on the current collector surface by a sputtering method, a deposition method, and the like. The inventors of the present invention further found that the lithium-nickel-containing composite oxide has a higher specific resistance compared with the lithium-cobalt-containing composite oxide and current does not easily flow at the time of a short circuit, and that sufficient contribution can be made for curbing heat generation.

The inventors of the present invention have furthermore found a specific configuration in a stacked or wound electrode assembly including an electrode unit having one positive electrode, one negative electrode, and one separator interposed therebetween, wherein the negative electrode contains an alloy-based negative electrode active material, the configuration being such that a specific relationship exists between the capacity of the electrode assembly and the number of stacking or winding of the electrode unit(s). According to this configuration, an internal short circuit due to a nail penetration test occurs only between the current collectors and substantially does not spread any further, and therefore, an internal short circuit hardly occurs between the active material layers. Even if an internal short circuit occurs between the active material layers, the intenral short circuit is sufficiently suppressed and is unlikely to spread any further. Based on the foregoing findings, the inventors of the present invention have reached the present invention.

The present invention relates to a lithium ion secondary battery including:

a positive electrode including a positive electrode current collector, and a positive electrode active material layer containing a positive electrode active material capable of absorbing and desorbing lithium;

a negative electrode including a negative electrode current collector, and a negative electrode active material layer containing a negative electrode active material capable of absorbing and desorbing lithium and having a melting temperature of 1200° C. or less in a lithium-absorbed state;

a separator; and

an electrolyte.

The negative electrode active material layer preferably has a resistance of 0.4 Ω·cm² or more in the thickness direction thereof under a pressure of 5 MPa.

Further preferably, a total resistances of the negative electrode active material layer and the positive electrode active material layer in the thickness direction thereof is 1.0 Ω·cm² or more under a pressure of 5 Mpa.

The positive electrode active material is preferably a lithium-nickel-containing composite oxide that contains lithium and nickel.

The lithium-nickel-containing composite oxide is preferably at least one selected from the group consisting of a lithium-nickel-containing composite oxide represented by the general formula (1), a lithium-nickel-containing composite oxide represented by the general formula (2), and a lithium-nickel-containing composite oxide represented by the general formula (3) shown below.

LiNi_{(1-a-b-c-d)}CoₐAl_{b}M1_{c}M2_{d}O₂ (1)

where M1 represents at least one element selected from the group consisting of Mn, Ti, Y, Nb, Mo, and W, M2 represents a mixture of Mg and Ca and may include one or both of Sr and Ba, and 0.05≦a≦0.35, 0.005≦b≦0.1, 0.0001≦c≦0.05, and 0.0001≦d≦0.05.

LiNiₑCo_{f}Mn_{g}M3ₕO₂ (2)

where M3 represents at least one selected from the group consisting of Mg, Ti, Ca, Sr, and Zr, and 0.25≦e≦0.5, 0≦f≦0.5, 0.25≦g≦0.5, and 0≦h≦0.1.

LiNiᵢMnⱼM4ₖO₄ (3)

where M4 represents at least one element selected from the group consisting of Co, Mg, Ti, Ca, Sr, and Zr, and 0.4≦i≦0.6, 1.4≦j≦1.6, and 0≦k≦0.2.

The negative electrode active material layer is preferably a thin film negative electrode active material layer containing a silicon-containing compound or a tin-containing compound as the negative electrode active material.

The thin film negative electrode active material layer preferably has a thickness of 3 to 50 μm.

The thin film negative electrode active material layer preferably includes a plurality of columns containing the silicon-containing compound or the tin-containing compound.

The plurality of columns are preferably provided so as to extend from the negative electrode current collector surface toward the outside of the negative electrode current collector, and to be separated from each other.

The columns preferably extends in a direction perpendicular to the surface of the negative electrode current collector or in a direction tilted with respect to the direction perpendicular to the surface of the negative electrode current collector.

The columns are preferably a stack of chunks containing the silicon-containing compound or the tin-containing compound.

The silicon-containing compound is preferably at least one selected from the group consisting of silicon, a silicon oxide, a silicon nitride, a silicon carbide, a silicon-containing alloy, and a silicon compound.

The tin-containing compound is preferably at least one selected from the group consisting of tin, a tin oxide, a tin nitride, a tin-containing alloy, and a tin compound.

In the case where the negative electrode active material layer contains a silicon compound or a tin compound as the negative electrode active material, it is preferable that the capacity Y of a stacked or wound electrode assembly including an electrode unit having a positive electrode, a negative electrode, and a separator interposed therebetween and being in a non-aqueous electrolyte impregnated state and the number X of stacking or wounding of the electrode unit(s) in the electrode assembly satisfy a relation Y/X>50.

It is further preferable that the electrode assembly has a flattened shape.

It is furthermore preferable that the number X of stacking or wounding of the electrode unit(s) in the electrode assembly is 25 or less.

### EFFECT OF THE INVENTION

A lithium ion secondary battery of the present invention has high capacity, output, and long life, and is excellent in cycle performance. Even a high capacity positive electrode active material and a high capacity negative electrode active material are used together, the lithium ion secondary battery of the present invention is excellently safe by using a negative electrode active material having a melting temperature of 1200° C. or less. For example, even if a nail penetration test is conducted, heat generation is significantly curbed, and occurrence of thermal runaway is reliably prevented. That is, a high capacity positive electrode active material can be used along with a high capacity negative electrode active material, and therefore high capacity and high output can be easily achieved.

### BRIEF DESCRIPTION OF THE DRAWINGS

FIG. 1 is a vertical cross sectional view schematically illustrating a configuration of a lithium ion secondary battery according to an embodiment of the present invention.

FIG. 2 is a vertical cross sectional view schematically illustrating a configuration of a negative electrode according to another embodiment of the present invention.

FIG. 3 is a perspective view schematically illustrating a configuration of a negative electrode current collector included in the negative electrode shown in FIG. 2.

FIG. 4 is a vertical cross sectional view schematically illustrating a column included in a negative electrode active material layer of the negative electrode shown in FIG. 2.

FIG. 5 is a side view schematically illustrating a configuration of an electron beam deposition apparatus.

FIG. 6 is a side view schematically illustrating a configuration of a vapor deposition apparatus according to another embodiment.

FIG. 7 is a vertical cross sectional view schematically illustrating a configuration of the main part of a lithium ion secondary battery according to another embodiment of the present invention.

### BEST MODE FOR CARRYING OUT THE INVENTION

A lithium ion secondary battery of the present invention is characterized in that a specific negative electrode is used. The negative electrode used in the present invention includes a negative electrode current collector, and a negative electrode active material layer (in the following, referred to as also “meltable negative electrode active material layer”) formed on the surface of the negative electrode current collector, and the negative electrode active material layer contains a negative electrode active material capable of absorbing and desorbing lithium and having a melting temperature of 1200° C. or less in a lithium-absorbed state (in the following, referred to as “low-melting point negative electrode active material”). Based on such characteristics, a lithium ion secondary battery of the present invention can simultaneously achieve characteristics of high capacity and high output, and characteristics of high safety.

Also, by adjusting the resistance of the meltable negative electrode active material layer in the thickness direction thereof under a pressure of 5 MPa to 0.4 Ω·cm² or more, it is possible to keep or further improve characteristics of high capacity and high output, and improve safety even further. Furthermore, by adjusting the total resistances (combined resistance) of the negative electrode active material layer and the positive electrode active material layer in the thickness direction thereof under a pressure of 5 MPa to 1.0 Ω·cm² or more, it is possible to keep or further improve the above-described battery characteristics, and achieve more significant improvement in safety. The resistance of the negative electrode active material layer and the combined resistance can be adjusted, for example, by selecting active material types, and active material layer thicknesses.

Further, by using the lithium-nickel-containing composite oxide as the positive electrode active material contained in the positive electrode, capacity and output of the lithium ion secondary battery of the present invention further increase, and safety improves even more.

The reasons why the above-described excellent effects can be obtained in the present invention have not been fully clarified, but probably are as follows. The meltable negative electrode active material layer formed by using the low-melting point negative electrode active material exibits such characteristics that when it is exposed to a high temperature locally, only the region that is exposed to the high temperature melts. Therefore, in a battery including a negative electrode using the meltable negative electrode active material layer as a constituent, even if an internal short circuit occurred, the internal short circuit and heat generated therefrom do not easily spread from the internal short circuit area to other area. Thus, battery safety significantly improves.

Many of the alloy-based negative electrode active materials in a lithium-absorbed state have a melting point (melting temperature) of about 700 to 1100° C. Therefore, such alloy-based negative electrode active materials can be used as the low-melting point negative electrode active material of the present invention. When the meltable negative electrode active material layer is formed by using the alloy-based negative electrode active material, battery safety further improves. This is probably because the characteristics of the alloy-based negative electrode active material not only include the melting point in a lithium-absorbed state of 1200° C. or less, but also include the high electrode resistance. Due to the high electrode resistance, the spread of the internal short circuit can further be curbed efficiently.

In contrast, carbon materials, i.e., a conventional negative electrode active material, have a melting point of about 3000° C. Therefore, in a negative electrode including a negative electrode active material layer containing a carbon material, in the case where an internal short circuit occurred, initially the temperature is below 1000° C. at the occurrence of the internal short circuit, and the melting of the negative electrode active material layer is hardly limited to the internal short circuit area and may spread the internal short circuit to other area, causing further heat generation.

Further, when the negative electrode used in the present invention is used along with the lithium-nickel-containing composite oxide, upon occurrence of an internal short circuit in the battery, an electric current flow can be curbed and the amount of the heat generation can be decreased. This is probably not only because the lithium-nickel-containing composite oxide has high capacity, but also because the lithium-nickel-containing composite oxide has a higher specific resistance than that of a lithium-cobalt-containing composite oxide, and does not easily allow the electric current to pass through. However, such effects are confirmed only for the case where the lithium-nickel-containing composite oxide is used in combination with the negative electrode used in the present invention, and sufficient effects to curb the heat generation have not been confirmed in the case where it is used in combination with other negative electrodes.

When a nail penetration test is carried out for a lithium ion secondary battery of the present invention, the following phenomenon will probably occur.

When a nail is allowed to penetrate, initially, an internal short circuit occurs between the positive electrode current collector and the negative electrode current collector via the nail, and at the area where these current collectors and the nail are in contact and at its surrounding area, heat generates locally and the temperature exceeds 600° C. Due to this heat generation, in addition to aluminum of the positive electrode current collector around the nail, the negative electrode current collector and the negative electrode active material layer around the nail melt substantially selectively, and the contact between the negative electrode and the nail decreases than before or disappears. Thus, a short circuit between the positive electrode active material layer and the negative electrode active material layer via a nail is prevented, or the speed of the short circuit advancement can be significantly slowed.

Furthermore, even if a surface-to-surface short circuit is caused between the negative electrode active material layer and the positive electrode active material layer, by the partial melting of the negative electrode active material layer, the short circuit area decreases, which decreases the amount of short circuit current and curbs heat generation. When an alloy-based negative electrode active material is used as the low-melting point negative electrode active material, and the lithium-nickel-containing composite oxide is used as the positive electrode active material, due to the high electrode resistance of the alloy-based negative electrode active material and the high specific resistance of the lithium-nickel-containing composite oxide, it becomes difficult for the electric current to flow in both active material layers, and the amount of short circuit current that flows in the event of the surface-to-surface short circuit further decreases.

The negative electrode current collectors melt probabry due to two main factors. The first factor is the heat generation of the alloy-based negative electrode active material. Since the alloy-based negative electrode active material has a relatively high electrode resistance, it is effective in curbing the advancement of the internal short circuit between the active material layers. Additionally, since the nail penetration causes a weak electric current flow, the heat is generated to the degree that does not cause thermal runaway in the battery, thereby melting the negative electrode current collector locally.

Another factor is that the contact area between the negative electrode current collector and the nail is small. That is, the negative electrode of the present invention including the negative electrode current collector, and the negative electrode active material layer containing the alloy-based negative electrode active material has a high mechanical strength and does not easily deform compared with a conventional negative electrode. The strength at the interface between the negative electrode current collector and the negative electrode active material layer is high as well. Thus, even when a nail is penetrated, the negative electrode deformation does not easily occur, the exposure of the negative electrode current collector is minimized, the contact area between the negative electrode current collector and the nail becomes extremely small, and the heat generates locally at the contact portion. Therefore, the negative electrode current collector can be melted locally and quickly.

The melting of the negative electrode current collector is effective in further curbing the spread of the internal short circuit. It is probably considered that due to such a mechanism, heat generation due to an internal short circuit is curbed, and thermal runaway is prevented reliably. Without the local melting of the negative electrode active material layer, even if it becomes difficult for the electric current to flow in the positive electrode active material layer due to the usage of the lithium-nickel-containing composite oxide, it is not sufficient for stopping the advancement of the internal short circuit.

In a nail penetration test, there may be a case where the above-described internal short circuit occurs several times consecutively or several internal short circuits occur simultaneously. An electrode unit positioned in the first layer of the electrode assembly counted from the surface thereof can suppress the short circuit current, by virtue of the mechanism as described above. Note that the electrode unit is composed of one positive electrode, one negative electrode, and one separator interposed therebetween. However, when a short circuit occurs consecutively in several layers of electrode units, it may be difficult to stop the spread of the internal short circuit due to the local heat accumulation in each layer, and the like.

In order to solve this problem, the present invention provides an electrode assembly formed by stacking or winding an electrode unit(s) with a separator interposed therebetween, the electrode assembly having a configuration such that the capacity Y of the electrode assembly in a non-aqueous electrolyte impregnated state and the number X of stacking or wounding of the electrode unit(s) in the electrode assembly satisfy a relation Y/X>50. Note that this electrode assembly includes a silicon-containing compound or a tin-containing compound as the negative electrode active material. With such a configuration, while maintaining the capacity of the battery, it is possible to reduce the number of stacking or winding of the electrode unit(s) by, for example, adjusting the area of the electrode. As a result, even when an internal short circuit occurs several times consecutively during a nail penetration test, the number of short circuits can be reduced and the thermal runaway is reliably prevented within a short period of time.

Further, in a square battery including the electrode assembly satisfying the relation Y>50X and having a flattened shape, the force associated with the deformation of the electrode assembly during charge and discharge is hardly acuminated in the interior of the battery. By virtue of this, upon the completion of the internal short circuit between the current collectors, the pressure is easily released, improving the contact resistance between the active material layers. As a result, it is possible to more surely prevent the short circuit current from flowing between the active material layers.

A lithium ion secondary battery of the present invention can be configured similarly to conventional lithium ion secondary batteries, except for the use of the negative electrode including the meltable negative electrode active material layer with the low-melting point negative electrode active material contained therein, and being formed on the surface of the negative electrode current collector.

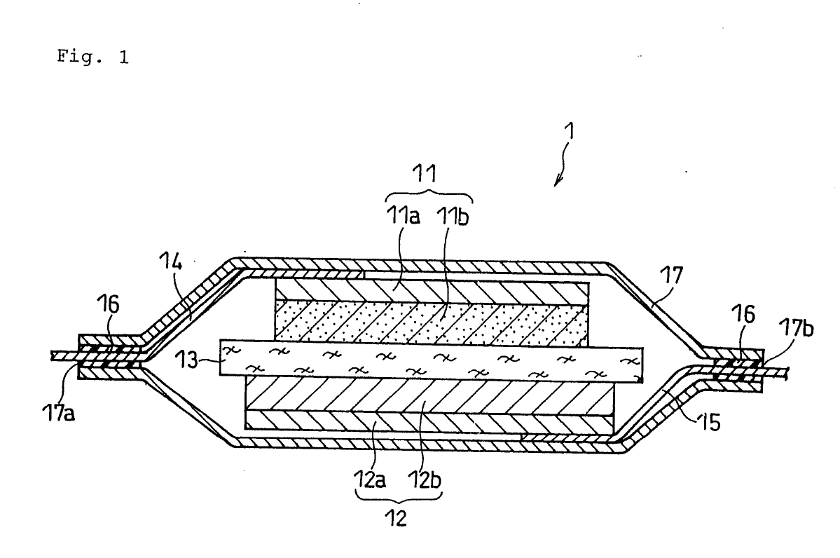

FIG. 1 is a vertical cross sectional view schematically illustrating a configuration of a lithium ion secondary battery 1 according to an embodiment of the present invention. The lithium ion secondary battery 1 includes a positive electrode 11, a negative electrode 12, a separator 13, a positive electrode lead 14, a negative electrode lead 15, gaskets 16, and an outer case 17. The lithium ion secondary battery 1 is a stack-type battery including an electrode assembly made by piling up the positive electrode 11, the separator 13, and the negative electrode 12. Although the electrode assembly comprises one electrode unit formed by stacking the positive electrode 11, the separator 13, and the negative electrode 12 in this embodiment, the electrode assembly is not limited thereto. In other words, in the present invention, an electrode assembly formed by stacking a plurality of the electrode units with the separator 13 interposed therebetween may be used.

In a stacked electrode assembly, it is preferable that the capacity Y (mAh) of the electrode assembly in a non-aqueous electrolyte impregnated state and the number X of stacking of the electrode units satisfy a relation Y/X>50. When Y/X is equal to or smaller than 50, if an internal short circuit occurs simultaneously or consecutively in several electrode units or at several points in one electrode unit, it may become impossible to sufficiently prevent the spread of the internal short circuit. Here, the number of stacking of the electrode units in a stacked electrode assembly is the number X of the electrode units stacked.

The number X in the electrode assembly is not particularly limited but preferably 25 or less in view of obtaining a highly safe battery that is thin in size and high in capacity and is capable of preventing the spread of internal short circuit. When the number of stacking far exceeds 30, the number of internal short circuits that occur during the nail penetration test is increased, and with the increasing number of internal short circuits, the positive electrode current collector is not sufficiently melted, causing a possibility that the internal short circuits may spread without being suppressed and occur also between the active material layers.

Conversely, when number X of stacking is 25 or less, since the reduction in the occurrence number of internal short circuit, the increase of the contact resistance between the active material layers, and the like can be achieved, and therefore, the positive electrode current collector is surely melted, significantly retarding the spread of the internal short circuit between the active material layers. In other words, the effect of melting of the current collector to shut off the flow of current and thus prevent the spread of the internal short circuit any further (hereinafter referred to as the “melting effect”) becomes noticeable.

The capacity Y of the electrode unit is preferably 900 to 4000 mAh, and more preferably 1200 to 3600 mAh. When the capacity Y is less than 900 mAh, for example, the output characteristics of the battery may be deteriorated. When the capacity Y exceeds 4000 mAh, even if the relation Y/X>50 is satisfied, the prevention of the internal short circuit achieved by the melting effect of the positive electrode current collector, the suppression of heat generation, and the like may become insufficient. It should be noted that as a method of adjusting to be Y/X>50, for example, a method of changing the dimensions (aspect ratio) of the positive electrode 11 and/or the negative electrode 12, a method of changing the number X of stacking or winding, and a method of changing the electrode area may be used.

The positive electrode 11 includes a positive electrode current collector 11a and a positive electrode active material layer 11b.

For the positive electrode current collector 11a, those commonly used in the field of the lithium ion secondary battery may be used, including for example, a porous or non-porous conductive substrate. Examples of the conductive substrate material include metal materials such as stainless steel, titanium, aluminum, aluminum alloys; and conductive resins. The porous conductive substrate includes, for example, mesh materials, net materials, punched sheets, laths, porous materials, foams, and fibrous molding materials (such as nonwoven fabric). The non-porous conductive substrate includes, for example, foils, sheets, and films. The thickness of the conductive substrate is usually 1 to 500 μm, preferably 1 to 50 μm, further preferably 10 to 40 μm, and particularly preferably 10 to 30 μm.

The positive electrode active material layer 11b is provided on one side or both sides of the current collector in the thickness direction thereof, and contains a positive electrode active material. The positive electrode active material layer 11b may further include a conductive agent, a binder, and the like along with the positive electrode active material.

For the positive electrode active material, known positive electrode active materials for lithium ion secondary batteries can be used, including without limitation, for example, a lithium-cobalt-containing composite oxide and a lithium-nickel-containing composite oxide. Among these, the lithium-nickel-containing composite oxide is preferably used.

Due to its high specific resistance, the lithium-nickel-containing composite oxide is effective in reducing the amounts of the short circuit current and hence the heat generation to prevent the spread of the internal short circuit particularly at the time of the surface-to-surface short circuit occurrence between the positive electrode active material layer and the negative electrode active material layer. When used in combination with the alloy-based negative electrode active material particularly, the effects are sufficiently brought out.

Known lithium-nickel-containing composite oxides can be used without limitation, as long as it is an oxide containing lithium and nickel. Specific examples include, a lithium-nickel-containing composite oxide represented by the general formula (1), a lithium-nickel-containing composite oxide represented by the general formula (2), and a lithium-nickel-containing composite oxide represented by the general formula (3) shown below.

LiNi_{(1-a-b-c-d)}CoₐAl_{b}M1_{c}M2_{d}O₂ (1)

where M1 represents at least one element selected from the group consisting of Mn, Ti, Y, Nb, Mo, and W,
M2 represents a mixture of Mg and Ca and may include one or both of Sr and Ba, and 0.05≦a≦0.35, 0.005≦b≦0.1, 0.0001≦c≦0.05, and 0.0001≦d≦0.05.

LiNiₑCo_{f}Mn_{g}M3ₕO₂ (2)

where M3 represents at least one element selected from the group consisting of Mg, Ti, Ca, Sr, and Zr, and
0.25≦e≦0.5, 0≦f≦0.5, 0.25≦g≦0.5, and 0≦h≦0.1.

LiNiᵢMnⱼM4ₖO₄ (3)

where M4 represents at least one element selected from the group consisting of Co, Mg, Ti, Ca, Sr, and Zr, and
0.4≦i≦0.6, 1.4≦j≦1.6, and 0≦k≦0.2.

Other than the above, for example, LiₓNiO₂, LiₓCo_{y}Ni_{1-y}O₂, LiₓNi_{1-y}M0_{y}O_{z} (M0 represents at least one element selected from the group consisting of Na, Mg, Sc, Y, Mn, Fe, Co, Ni, Cu, Zn, Al, Cr, Pb, Sb, V, and B; and 0≦x≦1.2, 0≦y≦0.9, and 2.0≦z≦2.3) can also be used.

When the lithium-nickel-containing composite oxide further includes cobalt, the nickel content is preferably higher than the cobalt content. Among these, the lithium-nickel-containing composite oxides of the formulae (1) to (3) are preferable. One of the lithium-nickel-containing composite oxides may be used singly, or two or more of the lithium-nickel-containing composite oxides may be used in combination as necessary.

For the conductive agent, those used commonly in the art may be used, including for example, graphites such as natural graphite and artificial graphite; carbon blacks such as acetylene black, ketjen black, channel black, furnace black, lamp black, and thermal black; conductive fibers such as carbon fiber and metal fiber; fluorocarbon; powder of metals such aluminum; conductive whiskers such as zinc oxide and potassium titanate; conductive metal oxides such as titanium oxide; and organic conductive materials such as phenylene derivatives. One of the conductive agents may be used singly, or two or more of the conductive agents may be used in combination as necessary.

For the binder as well, those used commonly in the art may be used, including for example, polyvinylidene fluoride (PVDF), polytetrafluoroethylene, polyethylene, polypropylene, an aramid resin, polyamide, polyimide, polyamide-imide, polyacrylonitrile, a polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyether sulfone, polyhexafluoropropylene, styrene-butadiene rubber, modified acrylic rubber, and carboxymethyl cellulose.

For the binder, a copolymer of at least two monomer compounds selected from the group consisting of tetrafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene may be used as well. One of the binders may be used singly, or two or more of the binders may be used in combination as necessary.

The positive electrode active material layer 11b can be formed, for example, by applying a positive electrode material mixture slurry containing the positive electrode active material, and, as necessary, a conductive agent and a binder on the surface of the positive electrode current collector 11a, and then drying. The positive electrode material mixture slurry can be prepared by dissolving or dispersing the positive electrode active material, and as necessary, a conductive agent and a binder in an organic solvent. For the organic solvent, for example, dimethylformamide, dimethylacetamide, methylformamide, N-methyl-2-pyrrolidone (NMP), dimethylamine, acetone, and cyclohexanone may be used.

When the positive electrode material mixture slurry includes the positive electrode active material, the conductive agent, and the binder, the ratio between these three components is not particularly limited. Preferably, the positive electrode active material is 80 to 98 wt %, the conductive agent is 1 to 10 wt %, and the binder is 1 to 10 wt % relative to the total of these three components used, and the values of these components may be selected appropriately from these ranges so that the total amount becomes 100 wt %. The thickness of the positive electrode active material layer 11b is appropriately selected according to various conditions. For example, when the positive electrode active material layer 11b is to be provided on both sides of the positive electrode current collector 11a, the total thickness of the positive electrode active material layer 11b is preferably about 50 to 100 μm.

The negative electrode 12 includes a negative electrode current collector 12a and a negative electrode active material layer 12b. For the negative electrode current collector 12a, those commonly used in the lithium ion secondary battery may be used, including for example, a porous or non-porous conductive substrate. Examples of the conductive substrate material includes metal materials such as stainless steel, titanium, nickel, copper, and copper alloy; and conductive resins. The porous conductive substrate includes, for example, mesh materials, net materials, punched sheets, laths, porous materials, foams, fibrous compacts (such as nonwoven fabric). The non-porous conductive substrate includes, for example, foils, sheets, and films. The thickness of the conductive substrate is usually 1 to 500 μm, preferably 1 to 50 μm, further preferably 10 to 40 μm, and particularly preferably 10 to 30 μm.

The negative electrode active material layer 12b is a meltable negative electrode active material layer containing the low-melting point negative electrode active material. The melting temperature (melting point) of the low-melting point negative electrode active material is 1200° C. or less. When the melting temperature exceeds 1200° C., there may be a possibility that the characteristic of melting only the internal short circuit area due to the local heat generation by the internal short circuit cannot be sufficiently brought out. The melting temperature as used here refers to a melting temperature of a low-melting point negative electrode active material when the low-melting point negative electrode active material is in a lithium-absorbed state.

Additionally, the negative electrode active material layer 12b preferably has a resistance of 0.4 Ω·cm² or more, further preferably 1.0 Ω·cm² or more, and still further preferably 5.0 Ω·cm² or more in the thickness direction thereof under a pressure of 5 MPa. With a resistance of below 0.4 Ω·cm², curbing the heat generation at the time of an internal short circuit, espetially at the time of surface-to-surface short circuit may become difficult.

The negative electrode active material layer 12b is formed on one side of the negative electrode current collector 12a in the thickness direction thereof, but may be formed on both sides, without limitation. The negative electrode active material layer 12b may include, for example, the low-melting point negative electrode active material, and a vary small amount of impurities that are inevitably included. The negative electrode active material layer 12b may include a known negative electrode active material and additives, along with the low-melting point negative electrode active material, to the extent that the characteristics of the low-melting point negative electrode active material are not impaired. Furthermore, the negative electrode active material layer 12b preferably is an amorphous thin film or a thin film that is low in crystallinity containing a low-melting point negative electrode active material and having a thickness of 3 to 50 μm. This makes it easy to adjust the resistance of the negative electrode active material layer 12b in the thickness direction thereof under a pressure of 5 MPa to 0.4 Ω·cm² or more.

Examples of the low melting point negative electrode active material include an alloy-based negative electrode active material such as a silicon-containing compound and a tin-containing compound. The melting temperature of the alloy-based negative electrode active material is about 700 to 1100° C.

Examples of the silicon-containing compound include silicon, silicon oxides, silicon nitrides, silicon-containing alloys, silicon compounds, and solid solutions thereof. The silicon oxides include, for example, silicon oxide represented by the composition formula: SiO_{α} (0.05<α<1.95). The silicon carbides include, for example, silicon carbide represented by the composition formula: SiC_{β} (0<β<1). The silicon nitrides include, for example, silicon nitride represented by the composition formula: SiN_{γ} (0<γ<4/3).

The silicon-containing alloys include, for example, an alloy containing silicon and at least one element selected from the group consisting of Fe, Co, Sb, Bi, Pb, Ni, Cu, Zn, Ge, In, Sn, and Ti. The silicon compounds include, for example, a compound in which silicon included in silicon, silicon oxides, silicon nitrides, or silicon-containing alloys is partly replaced with at least one element selected from the group consisting of B, Mg, Ni, Ti, Mo, Co, Ca, Cr, Cu, Fe, Mn, Nb, Ta, V, W, Zn, C, N, and Sn.

Among these, silicon, and silicon oxides are particularly preferable.

The tin-containing compounds include, for example, tin, tin oxides, tin nitrides, tin-containing alloys, tin compounds, and solid solutions thereof. For the tin-containing compounds, preferably used are for example, tin; tin oxides such as SnO_{δ} (0<δ<2) and SnO₂; tin-containing alloys such as Ni—Sn alloys, Mg—Sn alloys, Fe—Sn alloys, Cu—Sn alloys, and Ti—Sn alloys; and tin compounds such as SnSiO₃, Ni₂Sn₄, and Mg₂Sn. Among these, tin, and tin oxides such as SnO_{β} (0<β<2) and SnO₂ are particularly preferable. Each of the silicon-containing compounds and the tin-containing compounds may be used singly, or may be used in combination of two or more.

The thin film negative electrode active material layer 12b may be formed on the surface of the negative electrode current collector 12a, for example, by known thin film-forming methods, such as a sputtering method, a deposition method, and a chemical vapor deposition (CVD) method.

The thin film including a low-melting point negative electrode active material, i.e., the negative electrode active material layer 12b, may be an aggregate of a plurality of columns extending in the same direction. These columns contain the low-melting point negative electrode active material, are separated from each other with spaces between adjacent columns, and extend in the same direction. When forming the thin film negative electrode active material layer of an aggregation of these columns, the negative electrode current collector preferably has a plurality of projections on the surface thereof, and the columns are preferably formed on the surface of the projections.

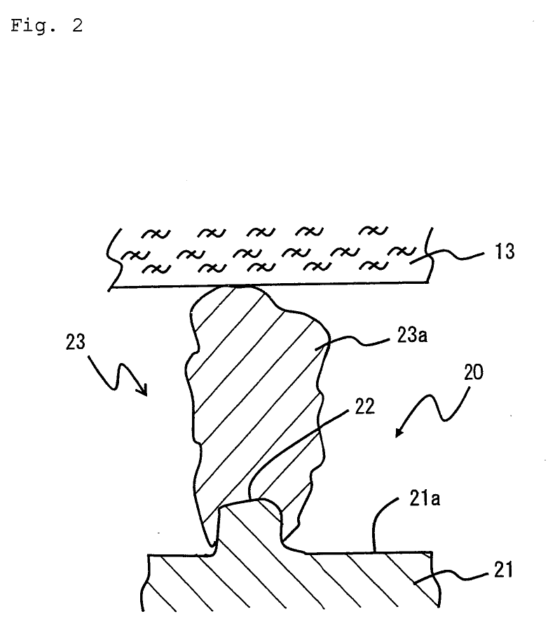

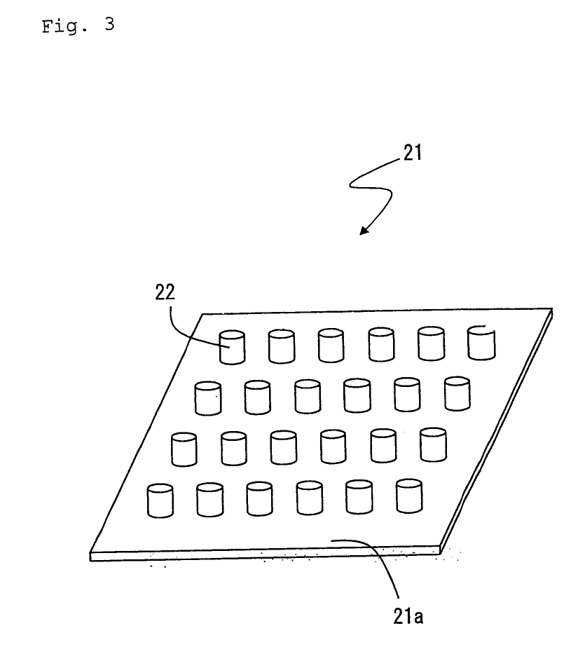

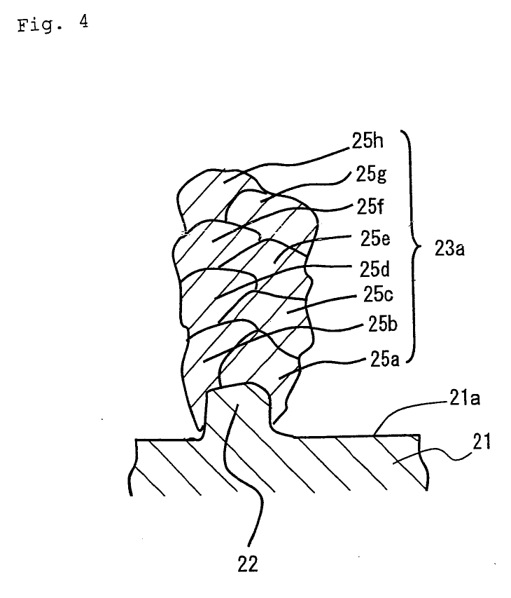

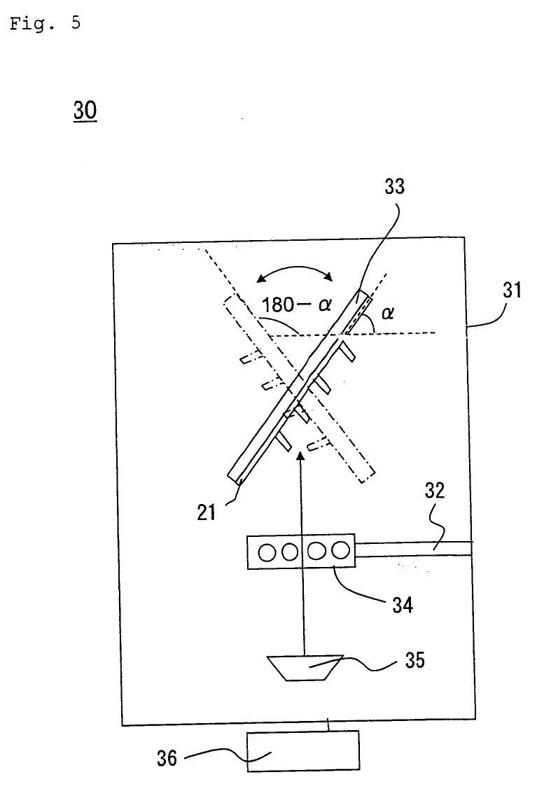

In other words, according to another embodiment of the present invention, a negative electrode including the negative electrode current collector having the plurality of projections on the surface thereof and the plurality of columns may be used. FIG. 2 is a vertical cross sectional view schematically illustrating a configuration of a negative electrode 20 according to another embodiment of a negative electrode in the present invention. FIG. 3 is a perspective view schematically illustrating a configuration of a negative electrode current collector 21 included in the negative electrode 20 shown in FIG. 2. FIG. 4 is a vertical cross sectional view schematically illustrating a configuration of a column 23a included in a negative electrode active material layer 23 of the negative electrode 20 shown in FIG. 2. FIG. 5 is a side view schematically illustrating a configuration of an electron beam deposition apparatus 30 for making the column 23a.

The negative electrode 20 includes the negative electrode current collector 21 and the thin film negative electrode active material layer 23.

As shown in FIG. 3, the negative electrode current collector 21 is characterized in that a plurality of projections 22 are provided on one or both surfaces in the thickness direction thereof, and other than that, the negative electrode current collector 21 has the same configuration as that of the negative electrode current collector 12a.

The projections 22 are provided so as to extend from a surface 21a of the negative electrode current collector 21 in the thickness direction thereof (in the following, simply called “surface 21a”) to the outside of the negative electrode current collector 21. Although there is no particular limitation as to the height of the projections 22, its average height is preferably about 3 to 10 μm. The height of the projections 22 is a length from the surface 21a to the furthest tip of the projection 22 in a direction perpendicular to the surface 21a where the projections 22 are formed. The cross-sectional diameter of the projection 22 in a direction parallel to the surface 21a is, for example, 1 to 50 μm, without limitation.

The average height of the projections 22 can be determined, for example, by observing a cross section of the negative electrode current collector 21 in the thickness direction thereof with a scanning electron microscope (SEM), measuring the height of, for example, 100 projections 22, and calculating an average from the obtained measurement values. The cross-sectional diameter of the projection 22 can also be measured in the same manner as the height of the projection 22. The plurality of projections 22 may not necessarily have the same height or the same cross-sectional diameter.

The projection 22 has a substantially planar top at the tip in the growth direction thereof. The growth direction is a direction of the extention of the projection 22 from the surface 21a to the outside thereof. With the planar top at the tip of the projection 22, bonding strength between the projections 22 and the columns 23a improves. This tip plane is further preferably substantially parallel to the surface 21a for improving the bonding strength.

The shape of the projection 22 is substantially circular. The shape of the projection 22 refers to a shape of the projection 22 viewed from above along the vertical direction when placing the current collector 21 so as to allow the surface opposite to the surface 21a of the negative electrode current collector 21 to coincide with the horizontal plane. The shape of the projection 22 is not limited to circular, and may be for example polygon or oval. The polygon preferably is a triangle to an octangle, in view of manufacturing costs. The polygon may also be a parallelogram, a trapezoid, or a diamond.

The number of the projections 22, and the spaces between the projections 22 are not particularly limited, but appropriately selected according to the size of the projections 22 (height, cross-sectional diameter, and the like), and the size of the columns 23a provided on the surface of the projections 22. For example, the number of the projections 22 is about 10000 to 10000000/cm². The projections 22 are preferably formed such that the distance between the axes of the adjacent projections 22 is about 2 to 100 μm.

Bumps, not shown, may be formed on the surface of the projection 22. With these bumps, for example, the bonding strength between the projections 22 and the columns 23a is further improved, and detachment of the columns 23a from the projections 22, and the spread of the detachment are reliably prevented. The bumps are provided so as to protrude from the surface of the projection 22 to the outside of the projection 22. A plurality of the bumps having a size smaller than the size of the projection 22 may be formed. The bumps may also be formed at the side face of the projection 22, so as to extend in the circumferential direction and/or in the growth direction of the projection 22. When the projections 22 have the planar top at the tip thereof, one or more bumps smaller than the projections 22 may be formed at the top, and one or more bumps further extending in a direction may be additionally formed at the top.

The negative electrode current collector 21 can be made by using a technique for forming irregularities on the surface of a metal plate such as for example metal foils, metal sheets, and metal films. To be specific, for example, a roll in which recess portions corresponding the projections 22 in size, shape, and arrangement are formed on the surface in the axial direction thereof (in the following, referred to as “projection-forming roll”) is used. When forming the projections 22 on one side of the metal plate, the projection-forming roll is brought into press contact with a roll with a smooth surface so as to allow their axes to be parallel, and a metal plate is allowed to pass through the portion of their press-contact, to carry out pressure-molding. In this case, at least the surface of the smooth-surface roll is preferably made of an elastic material.

In the case where the projections 22 are formed on both sides of the metal plate, two projection-forming rolls may be brought into press-contact with each other, so as to allow their axes to be parallel, and a metal plate may be allowed to pass through the portion of the press-contact to carry out pressure-molding. The pressure of the press-contact is appropriately selected based on various conditions. The various conditions include, for example, the material quality and the thickness of the metal plate, the shape and the size of the projections 22, and the thickness setting of the negative electrode current collector 12a to be obtained after the pressure molding.

The projection-forming roll may be made, for example, by forming, at predetermined positions on the surface of a ceramic roll, recess portions corresponding to the projections 22 in shape, size, and arrangement. For the ceramic roll, for example, those including a core roll and a thermal spray layer are used. For the core roll, for example, a roll made of iron, stainless steel, or the like can be used. The thermal spray layer is formed by uniformly thermal spraying a ceramic material such as chromic oxide on the surface of the core roll. The recess portions are formed on the thermal spray layer. For forming the recess portions, for example, a general laser used for molding and processing a ceramic material can be used.

A different type of projection-forming roll includes a core roll, a ground layer, and a thermal spray layer. The core roll is the same as the core roll of the ceramic roll. The ground layer is formed on the surface of the core roll. On the surface of the ground layer, recess portions corresponding to the projections 22 in shape, size, and arrangement are formed. The ground layer having the recess portions may be formed, for example, by molding a resin sheet having recess portions on one side thereof, and bonding the resin sheet to the core roll surface with the face of the resin sheet opposite to the face where the recess portions are formed wound around the core roll.

The synthetic resin contained in the resin sheet preferably has a high mechanical strength. Examples of the synthetic resin include thermosetting resins such as unsaturated polyester, thermosetting polyimide, epoxy resin, and fluorocarbon resin; and thermoplastic resins such as polyamide and polyetheretherketone. The thermal spray layer is formed by thermal spraying a ceramic material such as chromic oxide in conformity with the irregularities on the ground layer surface. Therefore, considering the thickness of the thermal spray layer, the recess portions on the ground layer are formed to be larger than the designed size of the recess portions by an amount corresponding to the thickness of the thermal spray layer.

Another different projection-forming roll includes a core roll and a cemented carbide layer. The core roll is the same as the core roll of the ceramic roll. The cemented carbide layer is formed on the core roll surface, and includes a cemented carbide such as tungsten carbide. The cemented carbide layer can be formed, for example, by thermal fitting or cool fitting a cemented carbide formed into a cylindrical shape on the core roll. In the thermal fitting of a cemented carbide layer, a cylindrical cemented carbide is warmed to expand, and fitted onto the core roll. In the cool fitting of a cemented carbide layer, the core roll is cooled to shrink, and inserted into the cylindrical cemented carbide. On the surface of the cemented carbide layer, for example, the recess portions corresponding to the projections 22 in shape, size, and arrangement are formed by for example laser processing.

In yet another type of projection-forming roll, recess portions corresponding to the projections 22 in shape, size, and arrangement are formed on the surface of a hard iron-based roll by for example laser processing. The hard iron-based roll is used, for example, for making metal foil by rolling metal. Examples of the hard iron-based roll include a roll made of high-speed steel and forged steel. The high-speed steel is an iron-based material with metals such as molybdenum, tungsten, vanadium added thereto and heat-treated to increase the hardness. The forged steel is an iron-based material made by heating steel ingots or steel slabs, forging with presses and hummers or rolling and forging, and further heat-treating the steel ingots or steel slabs. The steel ingots are made by casting a molten steel in a mold. The steel slabs are made from the steel ingots.

The one or more bumps on the surface of the projections 22 may be formed, for example, by the photoresist method. That is, a resist pattern is formed on the surface of the projections 22, and metal plating is carried out in conformity with the pattern. The bumps can also be formed by forming the projections 22 larger than the designed size, and removing predetermined portions of the surface of the projections 22 by etching. For forming the projections 22 themselves as well, a combination of the photoresist method and the plating method can be used.

As shown in FIG. 2, the thin film negative electrode active material layer 23 may be formed, for example, as an aggregate of a plurality of columns 23a extending from the surface of the projections 22 to the outside of the negative electrode current collector 21. The columns 23a extend in a direction perpendicular to the surface 21a of the negative electrode current collector 21 or in a direction tilted relative to the direction perpendicular to the surface 21a of the negative electrode current collector 21. Additionally, since the plurality of columns 23a are separated with spaces between the adjacent columns 23a, the stress resulting from expansion and contraction during charge and discharge is eased. In this way, the detachment of the thin film negative electrode active material layer 23 from the projections 22 is not easily caused, and the deformation of the negative electrode current collector 21 is not easily caused as well.

As shown in FIG. 4, the column 23a is further preferably formed as a columnar body formed by stacking eight columnar chunks 25a, 25b, 25c, 25d, 25e, 25f, 25g, and 25h. When forming the column 23a, the columnar chunk 25a is formed to cover the top of the projection 22, and then a portion of the side face continued therefrom. Then, the columnar chunk 25b is formed, so as to cover the remaining side face of the projection 22, and a portion of the top face of the columnar chunk 25a. That is, in FIG. 4, the columnar chunk 25a is formed at one edge of the projection 22 that includes the top face of the projection 22, and the columnar chunk 25b is partially stacked on the columnar chunk 25a but the remaining portion is formed at the other edge of the projection 22.

Further, the columnar chunk 25c is formed, so as to cover the remaining portion of the top face of the columnar chunk 25a, and a portion of the top face of the columnar chunk 25b. That is, the columnar chunk 25c is formed to contact mainly with the columnar chunk 25a. Further, the columnar chunk 25d is formed to contact mainly with the columnar chunk 25b. By stacking the columnar chunks 25e, 25f, 25g, and 25h alternately in the same manner, the column 23a is formed. By using a method such as a deposition method, the plurality of columns 23a are simultaneously formed, thereby forming the thin film negative electrode active material layer 23.

The column 23a can be formed, for example, by an electron beam deposition apparatus 30 as shown in FIG. 5. In FIG. 5, solid lines are used to illustrate the members in the deposition apparatus 30. The deposition apparatus 30 includes a chamber 31, a first pipe 32, a fixing board 33, a nozzle 34, a target 35, an electron beam generating apparatus (not shown), a power source 36, and a second pipe (not shown).

The chamber 31 is a pressure-tight container having an inner space, and contains the first pipe 32, the fixing board 33, the nozzle 34, and the target 35 therein. One end of the first pipe 32 is connected to the nozzle 34, and the other end extends to the outside of the chamber 31, and is connected to a raw material gas tank or a raw material gas producing apparatus (not shown) via a mass flow controller (not shown). Raw material gas includes, for example, oxygen, nitrogen and the like. The first pipe 32 supplies the raw material gas to the nozzle 34.

The fixing board 33 is a rotatably supported plate-like member, and the negative electrode current collector 21 can be fixed on one face of the fixing board 33 in the thickness direction thereof. The fixing board 33 is rotated between the position shown in the solid line and the position shown in the dot-dash line in FIG. 5. The position indicated by the solid line is a position at which the surface of the fixing board 33 on which the negative electrode current collector 21 is fixed faces the nozzle 34 located vertically below the fixing board 33 and the angle between the fixing board 33 and a line in the horizontal direction is α°. The position indicated by the dash dotted line is a position at which the surface of the fixing board 33 on which the negative electrode current collector 21 is fixed faces the nozzle 34 located vertically below the fixing board 33 and the angle between the fixing board 33 and a line in the horizontal direction is (180−α)°. The angle α° can be appropriately selected based on, for example, the size of the column 23a to be formed.

The nozzle 34 is provided between the fixing board 33 and the target 35 along the vertical direction, and is connected to one end of the first pipe 32. The nozzle 34 allows vapor of the alloy-based negative electrode active material moving upward in the vertical direction from the target 35 to be mixed with the raw material gas supplied from the first pipe 32, and supplies it to the surface of the negative electrode current collector 21 fixed onto the surface of the fixing board 33. The target 35 holds an alloy-based negative electrode active material or a raw material thereof.

The electron beam generating apparatus applies electron beam to the alloy-based negative electrode active material or the raw materials of the alloy-based negative electrode active material held in the target 35 to heat, thereby generating vapor of these. The power source 36 is provided outside the chamber 31, and electrically connected to the electron beam generating apparatus, to apply a voltage to the electron beam generating apparatus for generating electron beam. The second pipe introduces gas forming the atmosphere of the chamber 31. An electron beam deposition apparatus having the same configuration as that of the deposition apparatus 30 is commercially available from, for example, Ulvac Inc.

In the electron beam deposition apparatus 30, first of all, the negative electrode current collector 21 is fixed on the fixing board 33, and oxygen gas is introduced into the chamber 31. In such a state, electron beam is applied to the alloy-based negative electrode active material or the raw material of the alloy-based negative electrode active material in the target 35 to heat, thereby generating vapor of them. In this embodiment, silicon is used for the alloy-based negative electrode active material. The vapor generated goes up in the vertical direction, and is mixed with raw material gas upon passing through the nozzle 34, and further goes up to be supplied to the surface of the negative electrode current collector 21 fixed on the fixing board 33, thereby forming a layer including silicon and oxygen on the surface of the projections 22, which are not shown.

At this time, by setting the fixing board 33 to the position indicated by the solid line, the columnar chunk 25a shown in FIG. 4 is formed on the surface of the projection. Subsequently, by angularly displacing the fixing board 33 to the position indicated by the dash dotted line, the columnar chunk 25b as shown in FIG. 4 is formed. By rotating the position of the fixing board 33 alternately in this way, the column 23a, i.e., the stack of eight columnar chunks 25a, 25b, 25c, 25d, 25e, 25f, 25g, and 25h as shown in FIG. 4, is formed.

When the negative electrode active material is a silicon oxide represented by, for example, SiOₐ (0.05<a<1.95), the column 23a may be formed so as to provide a concentration gradient of oxygen in the thickness direction of the column 23a. To be specific, the oxygen content may be made higher in the proximity of the current collector 21, and may be decreased as the distance from the current collector 21 increases. In this way, the bonding strength between the columns 23a and the projections 22 further improves.

When the raw material gas is not supplied from the nozzle 34, a column 23a mainly composed of silicon or tin simple substance is formed. When the negative electrode current collector 12a is used instead of the negative electrode current collector 21 and the fixing board 33 is fixed in the horizontal direction without being rotated, a thin film negative electrode active material layer 12b can be formed.

When the negative electrodes 12 and 20 are used in a lithium ion secondary battery, a lithium metal layer may further be formed on the surface of the thin film negative electrode active material layers 12b and 23. In this case, the amount of the lithium metal may be set to an amount corresponding to the irreversible capacity reserved in the thin film negative electrode active material layers 12b and 23 during initial charge and discharge. The lithium metal layer may be formed, for example, by vapor deposition.

Referring back to FIG. 1, the separator 13 is provided between the positive electrode 11 and the negative electrode 12. For the separator 13, a sheet or film with predetermined ion permeability, mechanical strength, and nonconductivity is used. Specific examples of the separator 13 include a porous sheet or film such as a microporous film, woven fabric, and nonwoven fabric. The microporous film may be any of a single-layer film and a multi-layer film (composite film). The single-layer film is made of one type of material. The multi-layer film (composite film) is a stack of single-layer films made of one type of material, or a stack of single-layer films made of different materials.

For the material of the separator 13, various resin materials may be used. In view of durability, shutdown function, and battery safety, polyolefins such as polyethylene and polypropylene are preferable. The shutdown function is a function of shutting down the battery reaction, by closing the through holes at the time of abnormal heat generation in a battery to curb ion permeation. The separator 13 may be formed by stacking two or more layers of, for example, a microporous film, woven fabric, and nonwoven fabric, as necessary. The thickness of the separator 13 is generally 10 to 300 μm, preferably 10 to 40 μm, further preferably 10 to 30 μm, and still further preferably 10 to 25 μm. The porosity of the separator 13 is preferably 30 to 70%, and further preferably 35 to 60%. The porosity refers to the ratio of the total volume of the micropores present in the separator 13 relative to the volume of the separator 13.

The separator 13 is impregnated with an electrolyte with lithium ion conductivity. The electrolyte with lithium ion conductivity is preferably a non-aqueous electrolyte with lithium ion conductivity. The non-aqueous electrolyte includes, for example, liquid non-aqueous electrolytes, gelled non-aqueous electrolytes, and solid electrolytes (for example, polymer solid electrolyte).

The liquid non-aqueous electrolyte contains a solute (supporting salt) and a non-aqueous solvent, and further contains various additives as necessary. The solute is generally dissolved in a non-aqueous solvent. For example, the separator is impregnated with the liquid non-aqueous electrolyte.

For the solute, those commonly used in the art may be used, including for example, LiClO₄, LiBF₄, LiPF₆, LiAlCl₄, LiSbF₆, LiSCN, LiCF₃SO₃, LiCF₃CO₃, LiAsF₆, LiB₁₀Cl₁₀, lithium lower aliphatic carboxylate, LiCl, LiBr, LiI, LiBCl₄, borates, and imide salts.

Examples of the borates include bis(1,2-benzenedioleate(2-)-O,O′) lithium borate, bis(2,3-naphthalenedioleate(2-)-O,O′) lithium borate, bis(2,2′-biphenyldioleate(2-)-O,O′) lithium borate, and bis(5-fluoro-2-oleate-1-benzenesulfonic acid-O,O′) lithium borate. Imide salts include, for example, bis(trifluoromethanesulfonyl) imide lithium ((CF₃SO₂)₂NLi), trifluoromethanesulfonyl nonafluorobutane sulfonyl imide lithium ((CF₃SO₂)(C₄F₉SO₂)NLi), and bis(pentafluoroethanesulfonyl) imide lithium ((C₂F₅SO₂)₂NLi). One of the solutes may be used singly, or two or more of the solutes may be used in combination as necessary. The amount of the solute to be dissolved in the non-aqueous solvent is preferably in the range of 0.5 to 2 mol/L.

For the non-aqueous solvent, those commonly used in the art may be used, including for example, cyclic carbonate, chain carbonate, and cyclic carboxylate. Examples of the cyclic carbonate include propylene carbonate (PC), ethylene carbonate (EC) and the like. Examples of the chain carbonate include diethyl carbonate (DEC), ethyl methyl carbonate (EMC), dimethyl carbonate (DMC) and the like. Examples of the cyclic carboxylate include γ-butyrolactone (GBL), γ-valerolactone (GVL) and the like. One of the non-aqueous solvents may be used singly, or two or more of the non-aqueous solvents may be used in combination as necessary.

Examples of the additive include a material for improving charge and discharge efficiency, and a material for inactivating a battery. For example, the material for improving charge and discharge efficiency decomposes on the negative electrode and forms a coating with a high lithium ion conductivity to improve charge and discharge efficiency. Specific examples of such a material include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinyl ethylene carbonate (VEC), and divinyl ethylene carbonate. These may be used singly, or may be used in combination. Among these, at least one selected from the group consisting of vinylene carbonate, vinyl ethylene carbonate, and divinyl ethylene carbonate is preferable. In the above compounds, a portion of the hydrogen atoms may be replaced with a fluorine atom.

For example, the material for inactivating a battery decomposes at the time of battery overcharge and forms a coating on the electrode surface to inactivate the battery. Examples of such a material include benzene derivatives. Examples of the benzene derivatives include a benzene compound including a phenyl group and a cyclic compound group adjacent to the phenyl group. For the cyclic compound group, for example, a phenyl group, a cyclic ether group, a cyclic ester group, a cycloalkyl group, and a phenoxy group are preferable. Specific examples of the benzene derivative include cyclohexylbenzene, biphenyl, and diphenylether. The benzene derivative may be used singly, or may be used in combination of two or more. However, the benzene derivative content in the liquid non-aqueous electrolyte is preferably 10 parts by volume or less per 100 parts by volume of the non-aqueous solvent.

The gelled non-aqueous electrolyte includes a liquid non-aqueous electrolyte and a polymer material for retaining the liquid non-aqueous electrolyte. The polymer material used here is capable of gelling liquid. For the polymer material, those commonly used in the art may be used, including for example, polyvinylidene fluoride, polyacrylonitrile, polyethylene oxide, polyvinyl chloride, polyacrylate, and polyvinylidene fluoride.

The solid electrolyte includes, for example, a solute (supporting salt) and a polymer material. For the solute, those described as examples in the above may be used. Examples of the polymer material include polyethylene oxide (PEO), polypropylene oxide (PPO), and a copolymer of ethylene oxide and propylene oxide.

Referring to the positive electrode lead 14, one end of the positive electrode lead 14 is connected to the positive electrode current collector 11a, and the other end thereof is brought out of the lithium ion secondary battery 1 from an opening 17a of the outer case 17. Referring to the negative electrode lead 15, one end of the negative electrode lead 15 is connected to the negative electrode current collector 12a, and the other end thereof is brought out of the lithium ion secondary battery 1 from an opening 17b of the outer case 17. For the positive electrode lead 14 and the negative electrode lead 15, any of those commonly used in the field of lithium ion secondary batteries can be used.

The openings 17a and 17b of the outer case 17 are sealed by the gaskets 16. For the gaskets 16, for example, various resin materials can be used. Also for the outer case 17, those used commonly in the field of lithium ion secondary batteries can be used. The openings 17a and 17b of the outer case 17 may be directly sealed, for example, by welding without using the gaskets 16.

The lithium ion secondary battery 1 can be made, for example, as follows. First, one end of the positive electrode lead 14 is connected to the positive electrode current collector 11a of the positive electrode 11, at the face opposite to the face where the positive electrode active material layer 11b is formed. Similarly, one end of the negative electrode lead 15 is connected to the negative electrode current collector 12a of the negative electrode 12, at the face opposite to the face where the thin film negative electrode active material layer 12b is formed. Then, the positive electrode 11 and the negative electrode 12 are stacked with the separator 13 interposed therebetween, thereby preparing an electrode assembly. At this time, the positive electrode 11 and the negative electrode 12 are disposed so that the positive electrode active material layer 11b and the negative electrode active material layer 12b face each other. This electrode assembly is inserted in the outer case 17 along with the electrolyte, and the other ends of the positive electrode lead 14 and the negative electrode lead 15 are brought out of the outer case 17. In such a state, the openings 17a and 17b are welded with the gaskets 16 interposed therebetween while decreasing the pressure in the outer case 17 under vacuum, thereby obtaining the lithium ion secondary battery 1.

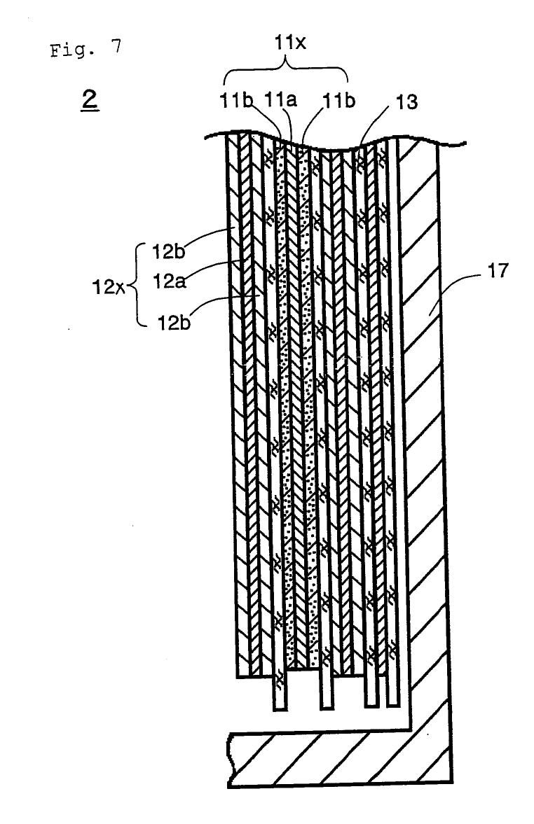

FIG. 7 is a vertical cross sectional view schematically illustrating a configuration of the main part of a lithium ion secondary battery 2 according to another embodiment of the present invention. Since the lithium ion secondary battery 2 is analogous to the lithium ion secondary battery 1, the corresponding components are denoted by the same reference numerals and the descriptions thereof are omitted.

The lithium ion secondary battery 2 is a square battery including a wound electrode assembly formed by winding an electrode unit with the separator 13 interposed, the electrode assembly having a flat shape. In a positive electrode 11x, the positive electrode active material layer 11b is formed on both sides of the positive electrode current collector 11a. Likewise, in a negative electrode 12x, the negative electrode active material layer 12b is formed on both sides of the negative electrode current collector 12a. The configuration of the lithium ion secondary battery 2 is the same as that of the lithium ion secondary battery 1 except the above.

In the lithium ion secondary battery 2 also, it is preferable that the capacity Y (mAh) of the wound electrode assembly in a non-aqueous electrolyte impregnated state and the number X of winding in the wound electrode assembly satisfy the relation Y>50X. This provides the similar effect as provided in the stacked electrode assembly, enabling the conflicting characteristics, namely, the higher capacity and the safety, to be both achieved at a high level. Here, in a wound electrode assembly, the number X of winding of the electrode unit refers to the number obtained by multiplying the number of winding the electrode unit in a coil by two.

The battery case 17 is a square battery case. A square battery case made of metal is used as the battery case 17 in this embodiment; however, it is not a limiting example, and for example a stacked laminate film case or a synthetic resin case may be used. Among these, in view of the ease of producing a square battery case and other merits, a stacked laminate film is preferable.

As the stacked laminate film, it is possible to use one commonly used in the art, examples of which include a stack of a metal film and a resin film. Examples of the foregoing stack include a laminate film of acid-modified polypropylene/polyethylene terephthalate (PET)/Al foil/PET, a laminate film of acid-modified polypropylene/polyamide/Al foil/PET, a laminate film of ionomer resin/Ni foil/polyethylene/PET, a laminate film of ethylene vinyl acetate/polyethylene/Al foil/PET, and a laminate film of ionomer resin/PET/Al foil/PET.

The lithium ion secondary battery of the present invention can be used for applications similar to conventional lithium ion secondary batteries, and is particularly useful for a power source of portable electronic devices such as personal computers, mobile phones, mobile devices, personal digital assistants, and mobile game devices.

### EXAMPLES

The present invention is described in detail with reference to examples, comparative examples, and experimental examples in the following.

### Example 1

### (1) Positive Electrode Active Material Preparation

An aqueous solution with a metal ion concentration of 2 mol/L was prepared by adding sulfates of Co and Al in an aqueous solution of NiSO₄ so that the molar ratio between Ni, Co, and Al was 7:2:1 (Ni:Co:Al=7:2:1). To this aqueous solution, a sodium hydroxide solution of 2 mol/L was dropped gradually while stirring to neutralize, thereby producing a ternary precipitate having a composition represented by Ni_{0.7}Co_{0.2}Al_{0.1}(OH)₂ by coprecipitation. This precipitate was separated by filtration, washed with water, and dried at 80° C., thereby obtaining a composite hydroxide. As a result of measuring the average particle size of the obtained composite hydroxide with a particle size distribution meter (product name: MT 3000, manufactured by Nikkiso Co., Ltd.), it was found that the average particle size was 10 μm.

This composite hydroxide was heated in an atmosphere at 900° C. for 10 hours for a heat treatment, to obtain a ternary composite oxide having a composition represented by Ni_{0.7}Co_{0.2}Al_{0.1}O. Lithium hydroxide monohydrate was added so that the sum of the number of atoms of Ni, Co, and Al and the number of atoms of Li are equal, and heated in an atmosphere at 800° C. for 10 hours for a heat treatment, to obtain a lithium-nickel-containing composite metal oxide having a composition represented by LiNi_{0.7}Co_{0.2}Al_{0.1}O₂. As a result of analyzing this lithium-containing composite metal oxide with powder X-ray diffraction, it was confirmed that it had a single phase, hexagonal crystal layer structure, and Co and Al were incorporated to be a solid solution. A positive electrode active material with the average particle size of the secondary particles of 10 μm, and a specific surface area determined by the BET method of 0.45 m²/g was obtained.

### (2) Positive Electrode Preparation

A positive electrode material mixture paste was prepared by sufficiently mixing 100 g of powder of the positive electrode active material obtained as described above, 3 g of acetylene black (conductive agent), 3 g of polyvinylidene fluoride (binder), and 50 ml of N-methyl-2-pyrrolidone (NMP). This positive electrode material mixture paste was applied on one side of aluminum foil (positive electrode current collector) with a thickness of 20 μm, dried, and rolled, to form a positive electrode active material layer. Afterwards, the positive electrode was cut out to give a size of 30 mm×180 mm. In the obtained positive electrode, the positive electrode active material layer carried on one side of the aluminum foil had a thickness of 60 μm, and a size of 30 mm×180 mm. A positive electrode lead was connected to the aluminum foil on a side opposite to the side where the positive electrode active material layer was formed.

### (3) Negative Electrode Preparation

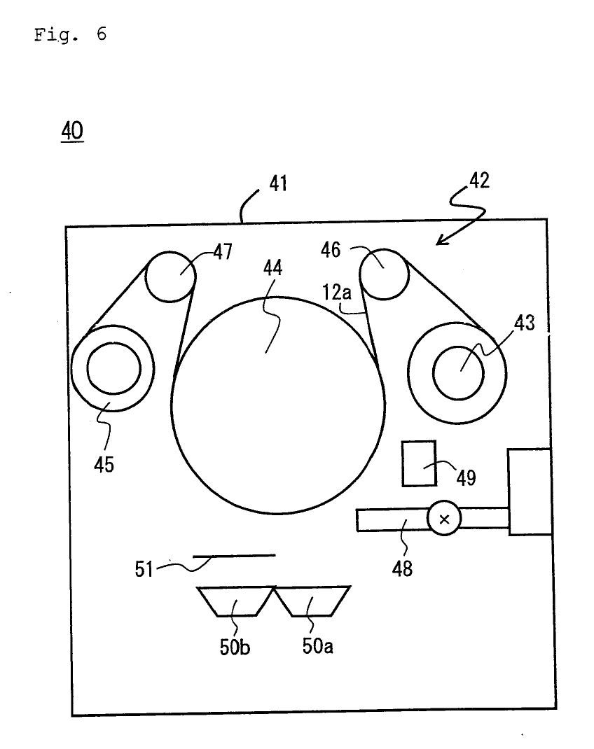

FIG. 6 is a side view schematically showing a configuration of a vapor deposition apparatus 40 for forming the thin film negative electrode active material layer. The vapor deposition apparatus 40 includes a vacuum chamber 41, a current collector transporting means 42, a raw material gas supplier 48, a plasma generating means 49, silicon targets 50a and 50b, a shielding plate 51, and an electron beam heating means, which is not shown. The vacuum chamber 41 is a pressure-tight container having an inner space in which the pressure can be decreased, and contains the current collector transporting means 42, the raw material gas supplier 48, the plasma generating means 49, the silicon targets 50a and 50b, the shielding plate 51, and the electron beam heating means in its inner space.

The current collector transporting means 42 includes a feed roller 43, a can 44, a pickup roller 45, and guide rollers 46 and 47. The feed roller 43, the can 44, and the guide rollers 46 and 47 are provided so as to be rotatable around their axes. On the feed roller 43, a long negative electrode current collector 12a is wound around. The can 44 has a larger diameter than other rollers, and has a cooling means, which is not shown, therein. When the negative electrode current collector 12a is transported on the surface of the can 44, the negative electrode current collector 12a is cooled. In this way, vapor of the alloy-based negative electrode active material deposits by the cooling, thereby forming a thin film.

The pickup roller 45 is provided so as to be rotatable around the axis by a driving means, which is not shown. One end of the negative electrode current collector 12a is fixed onto the pickup roller 45, and by the rotation of the pickup roller 45, the negative electrode current collector 12a is transported from the feed roller 43 via the guide roller 46, the can 44, and the guide roller 47. Then, the negative electrode current collector 12a with a thin film of the alloy-based negative electrode active material formed thereon is wound by the pickup roller 45.

The raw material gas supplier 48 supplies a raw material gas of, for example, oxygen and nitrogen to the vacuum chamber 41 when a thin film mainly composed of an oxide, a nitride, or the like of silicon or tin is to be formed. The plasma generating means 49 allows the raw material gas supplied from the raw material gas supplier 48 to form a plasma thereof. The silicon targets 50a and 50b are used when forming a thin film including silicon. The shielding plate 51 is provided so as to be movable in a horizontal direction at vertically below the can 44, and at vertically above the silicon targets 50a and 50b. The position in the horizontal direction of the shielding plate 51 is appropriately adjusted depending upon the forming status of the thin film at the surface of the negative electrode current collector 12a. The electron beam heating means applies an electron beam to the silicon targets 50a and 50b to heat, thereby generating vapor of silicon.

By using the vapor deposition apparatus 40, a thin film negative electrode active material layer (here, silicon thin film) with a thickness of 5 μm was formed on the surface of the negative electrode current collector 12a under the following conditions.

Pressure in Vacuum Chamber 41: 8.0×10⁻⁵ Torr

Negative Electrode Current Collector 12a:

electrolytic copper foil with a length of 50 m, a width of 10 cm, and a thickness of 35 μm (manufactured by FURUKAWA CIRCUIT FOIL Co., Ltd.)

Speed of Winding Negative Electrode Current Collector 12a by Pickup Roller 45 (transportation speed of negative electrode current collector 12a): 2 cm/min.

Raw Material Gas: Not supplied.

Targets 50a and 50b: single crystal silicon of 99.9999% purity (manufactured by Shin-Etsu Chemical Co., Ltd.)

Accelerating Voltage of Electron Beam: −8 kV

Electron Beam Emission: 300 mA

The obtained negative electrode was cut to give a size of 35 mm×185 mm, thereby making a negative electrode plate. In this negative electrode plate, lithium metal was allowed to deposit on the surface of the thin film negative electrode active material layer (silicon thin film). By depositing lithium metal, lithium was supplemented in an amount corresponding to the irreversible capacity stored in the thin film negative electrode active material layer at the time of initial charge and discharge. Lithium metal was deposited under an argon atmosphere, by using a resistance heating deposition apparatus (manufactured by ULVAC, Inc.). Lithium metal was placed in a tantalum boat in the resistance heating deposition apparatus, and the negative electrode was fixed so that the negative electrode active material layer faced the tantalum boat. Then, the deposition was carried out for 10 minutes by passing a current of 50 A through the tantalum boat in the argon atmosphere. Thus, the negative electrode plate used in the present invention is obtained.

### (4) Stack-Type Battery Preparation

An electrode assembly was prepared by stacking the positive electrode plate, a polyethylene microporous film (separator, product name: Hipore, thickness 20 μm, manufactured by Asahi Kasei Corporation), and the negative electrode plate so that the positive electrode active material layer and the thin film negative electrode active material layer faced with each other with the polyethylene microporous film interposed therebetween. The electrode assembly was inserted into an outer case of aluminum laminate sheet along with an electrolyte. For the electrolyte, a non-aqueous electrolyte in which LiPF₆ was dissolved in a mixed solvent of a 1:1 volume ratio of ethylene carbonate (EC) and ethyl methyl carbonate (EMC) at a concentration of 1.0 mol/L was used. Then, a positive electrode lead and a negative electrode lead were brought out from the openings of the outer case to the outside of the outer case, and while reducing the pressure in the outer case under vacuum, the openings of the outer case were welded, thereby making a lithium ion secondary battery of the present invention.

### Example 2

A lithium ion secondary battery of the present invention was made in the same manner as Example 1, except that the method for producing the negative electrode was changed as follows.

### Negative Electrode Preparation

A ceramic layer with a thickness of 100 μm was formed by thermal spraying chromic oxide on the surface of an iron roll with a diameter of 50 mm. A projection-forming roll was made by forming holes, i.e., circular recess portions with a diameter 12 μm and a depth of 8 μm, on the surface of this ceramic layer by laser processing. These holes were disposed in a close-packed arrangement, with a distance between the axes of adjacent holes of 20 μm. The bottom of these holes was substantially planar at its center, and a portion connecting the periphery of the bottom with the side face is formed so as to be rounded off.

Alloy copper foil (product name: HCL-02Z, thickness 20 μm, manufactured by Hitachi Cable) containing 0.03 wt % zirconia relative to the total amount was heated in an argon gas atmosphere at 600° C. for 30 minutes for annealing. This alloy copper foil was allowed to pass through a press-contact portion where the two projection-forming rolls were brought into press-contact with each other while applying a line pressure of 2 t/cm to pressure-mold the both sides of the alloy copper foil, thereby making a negative electrode current collector used in the present invention. As a result of observing a cross section of the obtained negative electrode current collector in the thickness direction thereof with a scanning electron microscope, it was found that projections were formed on the surface of the negative electrode current collector. The average height of the projections was about 8 μm.

The negative electrode active material layer with projections formed on the surface of the negative electrode current collector was made by using a commercially available vapor deposition apparatus (manufactured by ULVAC, Inc.) having the same structure as the electron beam vapor deposition apparatus 30 as shown in FIG. 5. Conditions for the deposition are as follows. The fixing board to which the negative electrode current collector with a size of 35 mm×185 mm was fixed was set so as to be angularly displaced between the position at an angle of 60° (α=60°) (position shown by solid line in FIG. 5) and the position at an angle of (180−α)=120° (dash dotted line as shown in FIG. 5) in an alternating manner with respect to the straight line in the horizontal direction. In this way, a negative electrode active material layer including the column in which the columnar chunks were stacked in eight layers as shown in FIG. 4 was formed. This negative electrode active material layer has grown in the direction where the projection extends, from the top and the side face in the proximity of the top of the projection.

Negative Electrode Active Material Raw Material (Evaporation Source): silicon, 99.9999% purity, manufactured by Kojundo Chemical Laboratory Co., Ltd.

Oxygen Released from Nozzle: 99.7% purity, manufactured by Nippon Sanso Corporation.

Flow Rate of Oxygen Released from Nozzle: 80 sccm

Angle α: 60°

Accelerating Voltage of Electron Beam: −8 kV

Emission: 500 mA

Deposition Period: 3 minutes

Thickness T of the negative electrode active material layer formed was 16 μm. The thickness of the negative electrode active material layer was determined by observing a cross section of the negative electrode in the thickness direction thereof with a scanning electron microscope, obtaining the length from the peak of the projection to the peak of the negative electrode active material layer for ten columns of the negative electrode active material layer formed on the projection surface and calculating the average of the obtained ten measured values. Also, as a result of determining an oxygen amount included in the negative electrode active material layer by the combustion method, it was clarified that the composition of the compound forming the negative electrode active material layer was SiO_{0.5}.

Then, lithium metal was deposited on the surface of the negative electrode active material layer. By depositing lithium metal, lithium was supplemented in an amount corresponding to the irreversible capacity stored in the negative electrode active material layer at the time of initial charge and discharge. Lithium metal was deposited under an argon atmosphere, by using a resistance heating deposition apparatus (manufactured by ULVAC, Inc.). Lithium metal was placed in a tantalum boat in the resistance heating deposition apparatus, and the negative electrode was fixed so that the negative electrode active material layer faced the tantalum boat. Then, the deposition was carried out for 10 minutes by passing a current of 50 A through the tantalum boat in the argon atmosphere.

### Comparative Example 1

A lithium ion secondary battery was made in the same mannar as Example 1, except that the positive electrode active material was changed to lithium cobalt oxide (LiCoO₂).

### Comparative Example 2

A lithium ion secondary battery was made in the same manner as Example 1, except that the method for producing the negative electrode was changed as follows.

### Negative Electrode Preparation

For the negative electrode active material, mesophase spherule graphitized at a high temperature of 2800° C. was used (in the following, referred to as “mesophase graphite”). A negative electrode material mixture slurry was prepared by mixing 100 parts by weight of this negative electrode active material with 2.5 parts by weight of SBR modified with acrylic acid (product name: BM-400B, solid content 40 wt %, manufactured by Zeon Corporation), 1 part by weight of carboxymethyl cellulose, and an appropriate amount of water with a double-armed kneader. This negative electrode material mixture slurry was applied on copper foil with a thickness of 10 μm, dried, rolled, and cut to give a predetermined size, thereby obtaining a negative electrode.

### Experimental Example 1

### Battery Capacity Evaluation

For the lithium ion secondary batteries of Examples 1 to 2, and Comparative Examples 1 to 2, a cycle of charge and discharge was repeated to a total of three times under the following conditions, and a discharge capacity at the third cycles was determined. The results are shown in Table 1.

Constant Current Charge: 200 mA, End Voltage 4.2 V.

Constant Voltage Charge: End Current 20 mA, Pause Interval of 20 minutes.

Constant Current Discharge: Current 200 mA, End Voltage 2.5 V, Pause Interval of 20 minutes.

### Electrode Resistance Evaluation

In the above-described battery capacity evaluation test, for the batteries after the third discharge capacity measurement, constant current charge and constant voltage charge were carried out under the same conditions as those of the capacity evaluation test. The battery after charge was disassembled, and the negative electrode was taken out and washed with a solvent (dimethyl carbonate). The negative electrode active material was cut out to a shape of 20 mm×20 mm with a tab. The negative electrode active material on one side was removed. Two sheets of the negative electrode were placed on one another so that their negative electrode active material layers face each other, and were further sandwitched with two Cu plates (upper plate and lower plate). A pressure of 5 MPa was applied, and the resistance of the negative electrode active material layer was determined by the direct current four point probe method between two tabs of the electrodes and the upper and lower Cu plates. The positive electrode was cut out to give a size of 20 mm×20 mm and sandwitched between two negative electrodes, and the total resistances of the negative electrode active material layer and the positive electrode active material layer (combined resistance) was measured in the same manner. For the batteries of Examples 1 to 2 and Comparative Examples 1 to 2, the resistance of the negative electrodes used and the combined resistance of the positive electrode and the negative electrode are shown in Table 1.

### Nail Penetration Test

In the above-described battery capacity evaluation test, for the battery after the third discharge capacity measurement, the constant current charge and the constant voltage charge were carried out in the same manner as this capacity evaluation test. The battery after charge was placed in a bath at a temperature of 60° C., and an iron nail (diameter 2.7 mm) was allowed to penetrate the battery at the speed of 1 mm/s, and after detecting the battery voltage drop due to the internal short circuit, the nail was stopped. The battery voltage of the battery at one second after the start of the short circuit in the battery by the nail, and the temperature of the battery surface at one minute after the start of the short circuit in the battery by the nail are shown in Table 1.

TABLE 1

| | | Electrode Resistance | | | |
|---|---|---|---|---|---|
| | | Evaluation | | | |
| | Battery | Negative | | Nail | |
| | Capacity | Electrode | | Penetration Test | |
| | Evaluation | Active Material | | | Battery |
| | Discharge | Layer | Combined | Battery | Surface |
| | Capacity | Resistance | Resistance | Voltage | Temperature |
| | (mAh) | (Ω · cm²) | (Ω · cm²) | (V) | (° C.) |
| Ex. 1 | 436 | 0.8 | 1.3 | 4.12 | 61 |
| Ex. 2 | 436 | 1.5 | 1.8 | 4.15 | 60 |
| Comp. | 378 | <0.01 | 0.28 | 0.5 | 120 |
| Ex. 1 | | | | | |
| Comp. | 330 | <0.01 | 0.16 | 0.25 | 125 |
| Ex. 2 | | | | | |

From Table 1, in the lithium ion secondary batteries of the present invention, even when the internal short circuit was forcibly generated by the nail penetration test, almost no drop in battery voltage occurred and the heat generation was significantly suppressed. This indicates that by configuring such that the negative electrode active material layer resistance and the combined resistance are high, it is possible to prevent the spread of the internal short circuit.

### Example 3

A belt-shaped positive electrode was produced in the same manner as in Example 1. The positive electrode was provided with an exposed portion of the positive electrode current collector, and to the exposed portion, one end of a positive electrode lead made of aluminum was connected. Further, a belt-shaped negative electrode was produced in the same manner as in Example 2. The negative electrode was provided with an exposed portion of the negative electrode current collector, and to the exposed portion, one end of a negative electrode lead made of nickel was connected. The same separator and non-aqueous electrolyte as used in Example 1 were used. The positive electrode and the negative electrode were wound with the separator interposed therebetween, to obtain a wound electrode assembly, the number of winding of which was 20. At this time, the widths and lengths of the positive electrode and the negative electrode were changed so that the battery had a design capacity of 1150 mAh or 1800 mAh or 3750 mAh.

When the design capacity was 1150 mAh, the positive electrode had a width of 29 mm and a length of 632 mm, and the negative electrode had a width of 31 mm and a length of 622 mm. When the design capacity was 1800 mAh, the positive electrode had a width of 35 mm and a length of 851 mm, and the negative electrode had a width of 37 mm and a length of 830 mm. When the design capacity was 3750 mAh, the positive electrode had a width of 57 mm and a length of 965 mm, and the negative electrode had a width of 59 mm and a length of 930 mm.

The wound electrode assembly thus produced was housed in a square battery case made of a laminate film of ethylene vinyl acetate/polyethylene/aluminum foil/polyethylene terephthalate. The other ends of the positive electrode lead and negative electrode lead were guided outside the battery case. Thereafter, the internal pressure of the battery case was reduced, and in this state, the non-aqueous electrolyte was injected into the battery case. Subsequently, the opening of the battery case was sealed. In such a manner, three lithium ion secondary batteries 3-1 to 3-3 of the present invention (square batteries) having different design capacities were produced.

### Comparative Example 3

A square lithium ion secondary battery was produced in the same manner as in Example 3 except that a positive electrode having a width of 30 mm and a length of 451 mm and a negative electrode having a width of 32 mm and a length of 450 mm were used, and the design capacity was changed to 800 mAh.

### Example 4

Two lithium ion secondary batteries 4-1 to 4-2 of the present invention being square batteries were produced in the same manner as in Example 3 except that: a positive electrode having a width of 57 mm and a length of 449 mm and a negative electrode having a width of 59 mm and a length of 387 mm were used and the number of winding was changed to four, or alternatively a positive electrode having a width of 57 mm and a length of 349 mm and a negative electrode having a width of 59 mm and a length of 330 mm were used and the number of winding was changed to 14; and the design capacity was changed to 1150 mAh.

### Comparative Example 4

A lithium ion secondary battery was produced in the same manner as in Example 4-1 except that the number of winding was changed to 30.

### Experimental Example 2

### Battery Capacity Evaluation

For the lithium ion secondary batteries of Examples 3 to 4, and Comparative Examples 3 to 4, a cycle of charge and discharge was repeated to a total of three times under the following conditions, and a discharge capacity at the third cycles was determined. The results are shown in Table 2. Here, C represents an hour rate, and 1C=(design capacity) mAh.

Constant Current Charge: 0.5 CmA, End Voltage 4.2 V.

Constant Voltage Charge: End Current 0.05 CmA, Pause Interval of 20 minutes.

Constant Current Discharge: Current 0.5 CmA, End Voltage 2.5 V, Pause Interval of 20 minutes.

### (Nail Penetration Test)

In the above-described battery capacity evaluation test, for the battery after the third discharge capacity measurement, the constant current charge and the constant voltage charge were carried out in the same manner as this capacity evaluation test. The battery after charge was placed in a bath at a temperature of 60° C., and an iron nail (diameter 1.2 mm) was driven into the battery at the speed of 1 mm/s until the nail penetrated through the battery. The battery voltage and the battery surface temperature immediately after the battery was pierced with the nail are shown in Table 2.

TABLE 2

| | | | | | | Nail Penetration | |
|---|---|---|---|---|---|---|---|
| | | | | | | Test | |
| | | | | | | | Battery |
| | | Battery | | Number | | | Surface |
| | | Design | | of | Discharge | Battery | Temper- |
| | | Capacity | | Wind- | Capacity | Voltage | ature |
| | | (mAh) | Y/X | ing | (mAh) | (V) | (° C.) |
| Ex. 3 | 1 | 1150 | 57.5 | 20 | 1145 | 4.06 | 62 |
| | 2 | 1800 | 90 | 20 | 1805 | 4.08 | 61 |
| | 3 | 3750 | 187.5 | 20 | 3780 | 4.11 | 61 |
| Ex. 4 | 1 | 1150 | 287.5 | 4 | 1143 | 4.14 | 61 |
| | 2 | 1150 | 82.1 | 14 | 1149 | 4.13 | 62 |

| | | | | | | |
|---|---|---|---|---|---|---|
| Comp. | 800 | 40 | 20 | 805 | 0.11 | >300 |
| Ex. 3 | | | | | | |
| Comp. | 1150 | 57.5 | 30 | 1145 | 0.15 | >300 |
| Ex. 4 | | | | | | |

From Table 2, in the lithium ion secondary batteries of the present invention, even when the internal short circuit was forcibly generated by the nail penetration test, almost no drop in battery voltage occurred and the heat generation was significantly suppressed. This indicates that by configuring such that Y/X is 50 or more and the number X of winding is 30 or less, it is possible to prevent the spread of the internal short circuit.

### INDUSTRIAL APPLICABILITY

The lithium ion secondary battery of the present invention can be used for applications similar to conventional lithium ion secondary batteries, and is particularly useful for a power source of portable electronic devices such as personal computers, mobile phones, mobile devices, personal digital assistants (PDA), mobile game devices, and camcorders. The lithium ion secondary battery of the present invention can be expected to be used for a secondary battery for assisting electro motors in hybrid electric vehicles and fuel cell automobiles; a power source for driving an electrically-powered tool, cleaner, and robot; and also for a power source for plug-in HEV.

1. A lithium ion secondary battery comprising:
an electrode unit having a positive electrode, a negative electrode, and a separator interposed between said positive electrode and said negative electrode,
said positive electrode including a positive electrode current collector and a positive electrode active material layer containing a positive electrode active material capable of absorbing and desorbing lithium, and
said negative electrode including a negative electrode current collector and a negative electrode active material layer containing a negative electrode active material capable of absorbing and desorbing lithium and having a melting temperature of 1200° C. or less in a lithium-absorbed state; and
an electrolyte.

2. The lithium ion secondary battery in accordance with claim 1, wherein the resistance of said negative electrode active material layer in the thickness direction thereof is 0.4 Ω·cm² or more under a pressure of 5 MPa.

3. The lithium ion secondary battery in accordance with claim 1, wherein a total resistance of said negative electrode active material layer and said positive electrode active material layer in the thickness direction thereof is 1.0 Ω·cm² or more under a pressure of 5 MPa.

4. The lithium ion secondary battery in accordance with claim 1, wherein said positive electrode active material is a lithium-nickel-containing composite oxide that contains lithium and nickel.

5. The lithium ion secondary battery in accordance with claim 1, wherein said lithium-nickel-containing composite oxide is at least one selected from the group consisting of a lithium-nickel-containing composite oxide represented by the general formula (1), a lithium-nickel-containing composite oxide represented by the general formula (2), and a lithium-nickel-containing composite oxide represented by the general formula (3) shown below,
LiNi_{(1-a-b-c-d)}CoₐAl_{b}M1_{c}M2_{d}O₂ (1)
where M1 represents at least one element selected from the group consisting of Mn, Ti, Y, Nb, Mo, and W,
M2 represents a mixture of Mg and Ca which may include one or both of Sr and Ba, and
0.05≦a≦0.35, 0.005≦b≦0.1, 0.0001≦c≦0.05, and 0.0001≦d≦0.05;
LiNiₑCo_{f}Mn_{g}M3ₕO₂ (2)
where M3 represents at least one element selected from the group consisting of Mg, Ti, Ca, Sr, and Zr, and
0.25≦e≦0.5, 0≦f≦0.5, 0.25≦g≦0.5, and 0≦h≦0.1; and
LiNiᵢMnⱼM4ₖO₄ (3)
where M4 represents at least one element selected from the group consisting of Co, Mg, Ti, Ca, Sr, and Zr, and
0.4≦i≦0.6, 1.4≦j≦1.6, and 0≦k≦0.2.

6. The lithium ion secondary battery in accordance with claim 1, wherein said negative electrode active material layer is a thin film negative electrode active material layer containing a silicon-containing compound or a tin-containing compound as said negative electrode active material.

7. The lithium ion secondary battery in accordance with claim 6, wherein said thin film negative electrode active material layer has a thickness of 3 to 50 μm.

8. The lithium ion secondary battery in accordance with claim 6, wherein said thin film negative electrode active material layer comprises a plurality of columns containing said silicon-containing compound or said tin-containing compound.

9. The lithium ion secondary battery in accordance with claim 8, wherein said plurality of columns are provided so as to extend from a surface of said negative electrode current collector to an outside of the negative electrode current collector, and to be separated from each other.

10. The lithium ion secondary battery in accordance with claim 8, wherein said plurality of columns extend in a direction perpendicular to the surface of said negative electrode current collector, or in a direction tilted with respect to the direction perpendicular to the surface of said negative electrode current collector.

11. The lithium ion secondary battery in accordance with claim 8, wherein said plurality of columns comprise a stack of chunks containing said silicon-containing compound or said tin-containing compound.

12. The lithium ion secondary battery in accordance with claim 8, wherein said silicon-containing compound comprises at least one selected from the group consisting of silicon, a silicon oxide, a silicon nitride, a silicon carbide, a silicon-containing alloy, and a silicon compound.

13. The lithium ion secondary battery in accordance with claim 8, wherein said tin-containing compound comprises at least one selected from the group consisting of tin, a tin oxide, a tin nitride, a tin-containing alloy, and a tin compound.

14. The lithium ion secondary battery in accordance with claim 6, wherein a plurality of said electrode units are stacked with a separator interposed therebetween to form a stacked electrode assembly, and the capacity Y of said stacked electrode assembly in a state of being impregnated with said non-aqueous electrolyte and the number X of stacking of said electrode unit in said stacked electrode assembly satisfy a relation Y/X>50.

15. The lithium ion secondary battery in accordance with claim 14, wherein the number X of stacking of said electrode units in said stacked electrode assembly is 25 or less.

16. The lithium ion secondary battery in accordance with claim 14, wherein the capacity Y is 900 to 4000 mAh.

17. The lithium ion secondary battery in accordance with claim 6, wherein said electrode unit and a separator are stacked and wound into a wound electrode assembly, and the capacity Y of said wound electrode assembly in a state of being impregnated with said non-aqueous electrolyte and the number X of winding of said electrode unit in said wound electrode assembly satisfy a relation Y/X>50.

18. The lithium ion secondary battery in accordance with claim 17, wherein said wound electrode assembly has a flattened shape.

19. The lithium ion secondary battery in accordance with claim 17, wherein the number X of winding of said electrode unit in said wound electrode assembly is 25 or less.

20. The lithium ion secondary battery in accordance with claim 17, wherein the capacity Y is 900 to 4000 mAh.
